(19) United States
(12) Patent Application Publication
(10) Pub. No.: US 2024/0125633 A1
(43) Pub. Date: Apr. 18, 2024

(54) DEVICE FOR DETERMINING A FLOW RATE OF A FLUID FLOW

(71) Applicants: Javad Rezanezhad Gatabi, San Marcos, TX (US); Emad Jafari Nodoushan, Austin, TX (US); Joshua Foss, Pflugerville, TX (US)

(72) Inventors: Javad Rezanezhad Gatabi, San Marcos, TX (US); Emad Jafari Nodoushan, Austin, TX (US); Joshua Foss, Pflugerville, TX (US)

(21) Appl. No.: 18/318,280

(22) Filed: May 16, 2023

Related U.S. Application Data
(60) Provisional application No. 63/364,778, filed on May 16, 2022.

(51) Int. Cl. G01F 1/38; G01F 15/14

(52) U.S. Cl. CPC G01F 1/38; G01F 15/14

(57) ABSTRACT

A device for determining a flow rate of a fluid flow, includes a fluid chamber configured to receive a portion of a fluid from the fluid flow, through an inlet fluid port. Further, the device includes a membrane configured to deform in response to the receipt of the portion of the fluid into the fluid chamber. The device further includes a sensor provided in a second chamber provided adjacent to the membrane on a side opposite to a side of the fluid chamber. The sensor is configured to detect deformation of the membrane and generate an input signal associated with the detected deformation of the membrane. Also, the device includes an electronic circuit board operatively coupled to the sensor. The electronic circuit board is configured to receive the input signal from the sensor and provide an output signal in correlation with the flow rate of the fluid flow.

### TECHNICAL FIELD

This present disclosure relates generally to flow meters, and more specifically, to flow meters including ultrasonic or sonic flow sensors for determining a flow rate of a fluid flow.

### BACKGROUND

Generally, fluid units are configured with flow meters for volumetric and/or mass flow rate measurement of fluids in and out of such fluid units. Typically, the flow meters may be categorized as mechanical flow meters, pressure-based flow meters, variable-area flow meters, and so forth. Normally, the type of flow meter is selected based on the application thereof.

Conventionally, the flow meters, such as a rotameter, employ a float or a physical object that moves along with the movement of the fluid in the fluid unit. The movement of the float is often detected using a sensor such as a reed switch or sensor and thereby indicating the flow of the fluid. However, such flow meters fail to provide an accurate flow measurement or can get stuck when the fluid is contaminated. Moreover, such flow meters may provide false positive signals or no signals at all to indicate that the fluid is flowing. Furthermore, over time the float or the physical object may get worn out due to fatigue thereby making the float or the physical object non-functional.

Additionally, sensors based on the float or the physical object also require a minimum flow rate to actuate or move the float or the physical object and trigger the sensor, thereby making it difficult to measure lower magnitudes of flow rates of the fluid. Notably, the minimum measurable flow rates of such flow meters are often higher than the flow rate desired to be measured. Furthermore, the flow meters fail to detect any variance or disruption in the flow of the fluid, especially when the variance or disruption is caused due to any downstream obstruction in the flow of fluid, a hose break, and a hose failure. In such cases, the said flow meters may continue to provide false positive signals regarding the flow of the fluid.

Generally, existing flow meters are fabricated using materials that are not suitable for all applications or may degrade while working with the fluids such as acidic or corrosive chemicals. Moreover, the existing flow meters may also contain components that are not made of suitable materials and may get damaged quickly, thereby requiring frequent replacements thereof making the existing flow meters cost intensive.

Therefore, in light of the foregoing discussion, there exists a need to overcome the aforementioned drawbacks associated with conventional flow meters.

### SUMMARY

An aspect of the invention provides a device for determining a flow rate of a fluid flow, the device comprising at least one fluid port configured to receive the fluid flow therethrough; a membrane, operatively coupled to the at least one fluid port, configured to change a position thereof based on the fluid flow; a sensor, operatively coupled to the membrane, configured to detect the change in the position of the membrane; and an electronic circuit board, operatively coupled to the sensor, configured to receive, from the sensor, an input signal associated with the detected change in the position of the membrane; and provide an output signal associated with the fluid flow based on a pre-defined threshold value of the fluid flow, wherein the at least one fluid port, the membrane, the sensor, and the electronic circuit board is arranged inside a housing such that the membrane separates the at least one fluid port from the sensor and the electronic circuit board.

Suitably, the device may comprise for example two fluid ports that are configured to receive the fluid flow therethrough. In this regard, when in use, the flow rate of the fluid increases and leads to a change in fluid pressure that causes the membrane to change position thereof, such as by expanding slightly, which is detected by the sensor. It will be appreciated that the sensors employ ultrasonic or other sound wavelengths to measure the slightest change in the membrane position as a result of the fluid pressure. Beneficially, the device may be used in a wide range of applications. Advantageously, depending on the flow rate and pressure requirements, the overall size of the at least one fluid port may be customized. Moreover, the size of the sensor housing and membrane may be adjusted based on the required fluid flow. Additionally, the electronic connectors could be swapped out and the wiring updated depending on the type of communication needed for the application. Moreover, the housing packages the device components, including its electronics arrangement, internally and thus renders the sensor a non-contact sensor. Such non-contact sensors may be used in applications employing acidic or corrosive chemicals.

Optionally, the device may be used for determining the exact or the relative flow rate of the fluid. Optionally, the device may be configured to determine a characteristic associated with the fluid flow, wherein the characteristic may be selected from a flow type, a fluid type, a temperature of the fluid, a viscosity of the fluid, and so on.

In an embodiment, the sensor is configured to detect the relative pressure difference resulting from the change in the position of the membrane. It will be appreciated that the slight change in the position of the membrane may be detected as a change or difference in the relative pressure of the fluid flow. Furthermore, the relative pressure difference is communicated as the input signal by the sensor and may be correlated to the fluid flow as the corresponding output signal. Moreover, the output signal may also report the actual fluid flow.

Suitably, the membrane may detect the relative pressure difference efficiently as compared to the conventional flow meters. Beneficially, the membrane may detect the lower relative pressure differences as well, when in use.

In an embodiment, the sensor is an ultrasonic or a sonic sensor. Suitably, the ultrasonic or sonic sensor is a non-contact sensor that may detect the fluid flow and a change in the fluid flow. Optionally, the ultrasonic or sonic sensor may also characterize a standard fluid flow and detect an abnormal fluid flow. Beneficially, the ultrasonic or sonic sensor may be used for the fluids such as air or liquid. It will be appreciated that the ultrasonic or sonic sensor may detect small changes in the membrane during the fluid flow, as the membrane deforms increasingly with an increase in the flow rate of the fluid flow. Advantageously, since the ultrasonic or sonic sensor may detect extremely small changes in the membrane, lower flow rates and minuscule changes in the flow rate may be detected accurately as compared to the conventional flow meters. In this regard, the ultrasonic or sonic sensors may detect the fluid flow specifically by employing semiconductor equipment therein.

In this regard, the ultrasonic or sonic sensor measures the velocity of the fluid using ultrasound or sound waves to calculate the volumetric flow rate of the fluid. Typically, the volumetric flow rate (namely, volume flow rate, rate of fluid flow, or volume velocity) is the volume of fluid that passes per unit of time and is represented by the symbol Q and the SI unit is cubic meters per second (m³/s). Moreover, when in use, the ultrasonic or sonic sensor transmits the ultrasound or sound waves at a frequency above the range of human hearing frequency to the membrane and receives the reflected ultrasound or sound waves that are hit by the membrane. Furthermore, the ultrasonic or sonic sensor depicts the traveled distance and time difference between the transmitted ultrasound or sound waves and the received ultrasound or sound waves. Optionally, the ultrasonic or sonic sensor may also measure the average velocity along the path of an emitted beam of ultrasound or sound, by averaging the difference in measured transit time between the pulses of ultrasound or sound propagating into and against the direction of the fluid flow or by measuring the frequency shift from the Doppler effect. The traveled distance and the time difference of the ultrasound or sound waves help in determining a flow type, a fluid type, a temperature of the fluid, a viscosity of the fluid, and so on.

In an embodiment, the membrane is arranged in a neutral position in the housing, wherein the neutral position is achieved by stretching the membrane with a pre-defined tension therein. Suitably, the membrane is held in the neutral position when there is no fluid flow. Moreover, to achieve the neutral position, the membrane is stretched to be held with a small amount of tension therein. Furthermore, optionally, the tension may be achieved with small mounting pins installed in the housing and the membrane stretched over the mounting pins. Optionally, other ways may also be used to accomplish the stretching of the membrane. Optionally, the surface area and thickness of the membrane may be adjusted to tune the sensitivity of the ultrasonic or sonic sensors to low flow rates.

In an embodiment, a fabrication material of the housing is selected from at least one of Polytetrafluoroethylene (PTFE), a fluoropolymer, and a plastic. It will be appreciated that the fabrication material of the housing may be a chemical-resistant material such as PTFE or some other fluoropolymer. Optionally, when the chemical resistance is not required, then a wide range of plastics such as acrylonitrile butadiene styrene (ABS), Delrin®, polyvinyl chloride (PVC), Polyether ether ketone (PEEK), and so forth may be used as the fabrication material of the housing.

In an embodiment, a fabrication material of the membrane is selected from at least one of an elastomer, a fluoropolymer, a synthetic rubber, a plastic, and any other similar material. Suitably, the said fabrication material is a chemical-resistant material. Beneficially, the chemical-resistant material prevents the membrane from getting damaged, when in use, or when exposed to acidic or corrosive chemicals for example. Optionally, fluoropolymers such as Viton®, Kalrez®, or any other similar material may be used as the fabrication material of the membrane. Optionally, a wide range of elastomers could be used as the fabrication material of the membrane.

In an embodiment, the electronic circuit board may be trained using machine learning and artificial intelligence, to receive, from the sensor, multiple input signals associated with the detected change in the position of the membrane due to a plurality of fluid flows and provide multiple respective output signals associated with the plurality of fluid flows based on multiple pre-defined threshold values of the plurality of fluid flows.

Suitably, the electronic circuit board is programmed to send digital or analog signals such as the output signal when fluid flow exists. The said digital or analog signal may be tuned depending on the minimum desired fluid flow threshold, thereby allowing for the detection of extremely low flow rates. Beneficially, the sensor could be programmed to have multiple flow thresholds. Additionally, depending on the process parameters or input conditions a different threshold may be used. Herein the process parameters may include the pressure, temperature, flow rate, and so forth, of the fluid. Moreover, the different multiple thresholds could be triggered with the input signal/communication to request multiple pre-defined threshold values of the plurality of fluid flow to be used.

In an embodiment, the device is further configured to generate a notification at a user device, associated with a user, based on the determined flow rate of the fluid flow when the fluid flow exceeds or is lower than the pre-defined threshold value. In this regard, when in use, the flow rate of the fluid flow exceeds or is lower than the pre-defined threshold value then the electronic circuit board is programmed to send the output signal as the notification or a warning to the user device indicating that the expected fluid flow is outside of operating threshold values. Optionally, the notification is implemented as an alarm. Optionally, the alarm levels may be set on a case-by-case basis, such as based on the amounts by which the flow rate levels exceed or are lower than the pre-defined threshold value. Optionally, the user device may be a mobile phone, a laptop, a desktop, and so forth. Optionally, the user may be an operator operating the device, an engineer, and so forth.

Optionally, the sensor may be programmed to have multiple threshold values of the flow rate based on the multiple fluids flowing. In this regard, the multiple flow thresholds could be pre-programmed or set up on installation and calibrated based on the flow for each fluid. Additionally, machine learning could be utilized to characterize the fluid flow pulses and generate a known pulse fingerprint. Furthermore, using the said pulse fingerprint the threshold may be more accurate and tightly controlled. Beneficially, such sensors with multiple flow thresholds may be used in a wide range of applications by adjusting at least one of the fluid ports, the overall size of the device, the membrane size, the electronic circuit board design, and so forth, depending upon the flow rates and pressure requirements.

Another aspect of the invention provides a computer program product comprising a non-transitory machine-readable data storage medium having stored thereon program instructions that, when accessed by a processor, cause the processor to determine a fluid flow.

Throughout the description and claims of this specification, the words “comprise” and “contain” and variations of the words, for example, “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples, and alternatives set out in the preceding paragraphs, in the claims and/or in the following description and drawings, and in particular the individual features thereof, may be taken independently or in any combination. That is, all embodiments and/or features of any embodiment can be combined in any way and/or combination unless such features are incompatible.

### BRIEF DESCRIPTION OF THE DRAWINGS

The summary above, as well as the following detailed description of illustrative embodiments, is better understood when read in conjunction with the appended drawings. To illustrate the present disclosure, exemplary constructions of the disclosure are shown in the drawings. However, the present disclosure is not limited to specific methods and instrumentalities disclosed herein. Moreover, those skilled in art will understand that the drawings are not to scale. Wherever possible, like elements have been indicated by identical numbers.

One or more embodiments of the invention will now be described, by way of example only, with reference to the accompanying drawings, in which:

FIG. 1A is a cross-sectional view of a device for determining a flow rare of a fluid flow, in accordance with an embodiment of the invention;

FIG. 1B is a zoomed view of the cross-sectional view of a membrane arranged inside a housing, in accordance with an embodiment of the invention;

FIG. 1C is an illustration of the housing of the device for determining the flow rate of the fluid flow, in accordance with an embodiment of the invention; and

FIG. 1D is a partial view of the device for determining the flow rate of the fluid flow, in accordance with an embodiment of the present invention.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

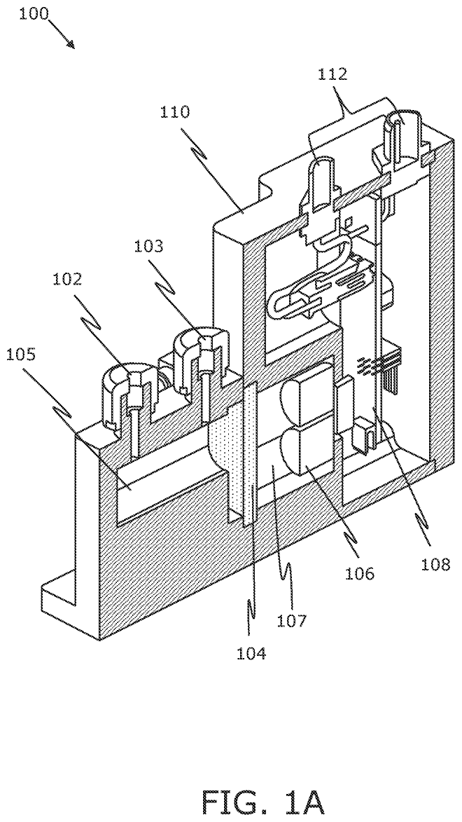

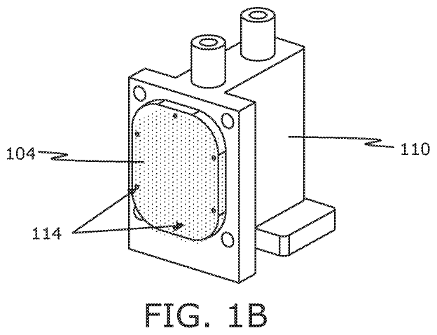

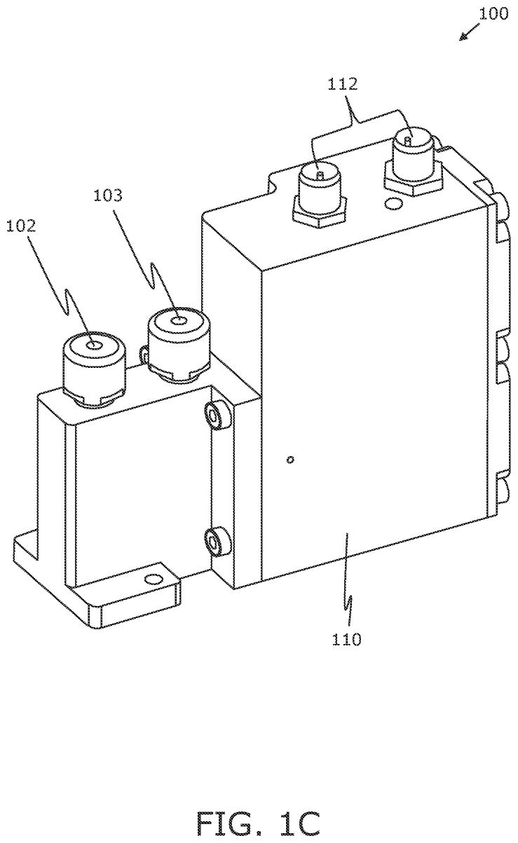

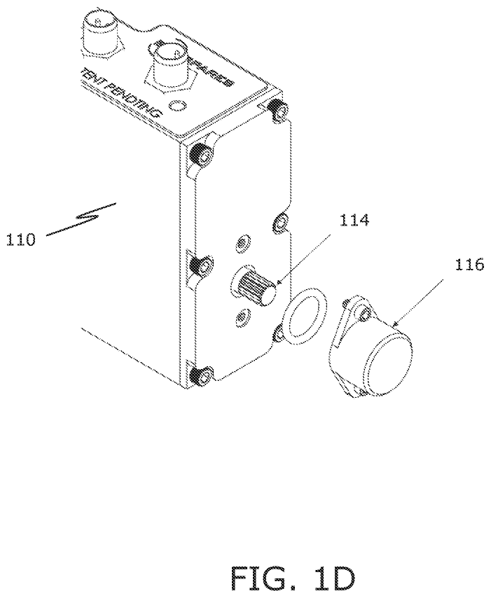

Referring to FIG. 1A, shown is a cross-sectional view of a device 100 for determining a flow rate of a fluid flow, in accordance with an embodiment of the invention. As shown, the device 100 includes a fluid chamber 105 configured to receive a portion of the fluid from the fluid flow. The fluid chamber 105 is fluidically coupled with an inlet fluid port 102 and an outlet fluid port 103. The portion of the fluid is received into the fluid chamber 105 through the inlet fluid port 104. A membrane 104 has been provided adjacent to the fluid chamber 105. The membrane 104 is configured to be deformed in response to receipt of the portion of the fluid in the fluid chamber 105. A second chamber 107 has been provided adjacent to the membrane 104 on a side opposite to a side of the fluid chamber 105.

Furthermore, the device 100 comprises a sensor 106 provided in the second chamber 107 configured to detect deformation of the membrane 104. In several embodiments of the invention, the sensor 106 is an ultrasonic transducer and is configured to detect the deformation of the membrane 104 by generating sonic and/or ultrasonic waves and sensing a total time taken by the sonic and/or the ultrasonic waves to travel to the membrane 104 and return to the sensor 106. Additionally, the device 100 comprises an electronic circuit board 108, operatively coupled to the sensor 106. The electronic circuit board 108 may be electrically coupled to the sensor 106. The electronic circuit board is configured to receive, from the sensor 106, an input signal associated with the detected deformation of the membrane 104. Further, the electronic circuit board 108 is configured to provide an output signal in correlation with the flow rate of the fluid flow, for example, based on a pre-defined threshold value of the flow rate of the fluid flow. It will be appreciated that the inlet fluid port 102, the membrane 104, the sensor 106, and the electronic circuit board 108 are arranged inside a housing 110 such that the membrane 104 separates the fluid chamber 105 from the sensor 106 and the electronic circuit board 108. Additionally, the device 100 comprises at least one electrical power terminal 112 for receiving electrical power from a power source (not shown).

Referring to FIG. 1B, shown is a zoomed view of the membrane 104 arranged inside the housing 110. As shown, in the absence of a fluid flow or any amount of fluid in the fluid chamber 105, the membrane 104 is held in a baseline non-activated position by stretching the membrane 104 over a plurality of mounting pins 114.

Referring to FIG. 1C, shown is an illustration of the housing 110 of the device 100 for determining the flow rate of the fluid flow, in accordance with an embodiment of the invention. As shown the housing 110 is used to package the components of the device 100, such as the membrane 104, the sensor 106, and the electronic circuit board 108, internally. The housing 110 protects the sensor 106 and the electronic circuit board 108 from contacting the fluid, thereby rendering the sensor 106 as a non-contact sensor. It will be appreciated that the inlet fluid port 102 and the at least one electrical power terminal 112 protrude from the housing 110.

Referring to FIG. 1D, the housing 110 includes an encoder 114 attached therewith. The encoder 114 is enclosed under an encoder cap 116 to prevent accidental movement of or contact with the encoder 114. In several embodiments of the invention, the sensor 106 can be operated in a plurality of modes (such as eight modes) and the encoder 114 serves at least three functions. (1) The encoder 114 can be used as a push button to switch between the plurality of modes of operation of the sensor 106, (2) the encoder 114 can be provided with a Light Emitting Diode (LED) capable of emitting several colors each indicating a current mode of operation of the sensor 106, and (3) the encoder 114 can be operated as a knob for adjustment of parameter values in each mode. Several example modes of operation of the sensor 106 have been presented below.

Mode 0: Run/functional Mode of the sensor 106. By default, the sensor 106 falls in this mode after powering on of the device 100. The LED of the encoder 114 is off in Mode 0 and rotating the encoder knob has no effect.

Mode 1: Mode 1 enables coarse tuning of the baseline while there is no flow. After entering this mode, the LED lights up with red color. The sensor 106 then performs the flow measurement and presents the measurement results on an analog output pin. By rotating the encoder knob clockwise, the signal gets shifted upward, and by rotating the knob counterclockwise the signal drifts downward. It is important to note that Mode 1 adjusts the physical ultrasonic wave which results in a baseline shift in the output. After rotating the encoder it takes 1-2 seconds for the algorithm to converge and the output signal to be stable.

Mode 2: Mode 2 allows for a gain set. In this mode, the sensor 106 does not perform any measurements. Instead, the analog output of the sensor 106 represents the gain level. A higher voltage will provide more sensitivity. Please note that by changing the gain, the baseline will also get shifted.

Mode 3: Mode 3 allows for the fine-tuning of the baseline. This mode is like Mode 1 with the difference being that Mode 3 directly adjusts the baseline of the output voltage instead of manipulating the ultrasonic wave. It allows for precise baseline adjustments.

Mode 4: Mode 4 lets a user adjust a threshold level for a digital output of the sensor 106. In this mode, the sensor 106 does not perform any flow measurement. Instead, the analog output presents the threshold value.

Mode 5: Mode 5 allows the user to adjust an integration time and filter the output signal. In this mode, the sensor 106 does not perform any flow measurement. Instead, the analog output presents the filtering/integration level. A higher voltage will provide a longer integration time to smooth the output signal and slow the response.

Mode 6: Mode 6 allows for a final test prior to saving the settings on the non-volatile memory. In this mode, the sensor 106 performs the normal measurements. The analog and digital outputs also present the normal outputs like the in the Run mode.

Mode 7: Mode 7 performs the saving process. By hopping over Mode 7, the sensor 106 goes to Mode 0 without saving the changed parameters (the new parameters remain in the temporary memory until a power cycle). If the user stops at Mode 7 for over 10 seconds, the sensor 106 will save the new settings on the non-volatile memory of the sensor 106, so the new settings would not be deleted after a power cycle. The sensor 106 automatically goes to Mode 0 after saving the parameters.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

Various modifications to these embodiments are apparent to those skilled in the art, from the description and the accompanying drawings. The principles associated with the various embodiments described herein may be applied to other embodiments. Therefore, the description is not intended to be limited to the embodiments shown along with the accompanying drawings but is to be providing the broadest scope consistent with the principles and the novel and inventive features disclosed or suggested herein. Accordingly, the invention is anticipated to hold on to all other such alternatives, modifications, and variations that fall within the scope of the present invention and appended claims.

1. A device for determining a flow rate of a fluid flow, the device comprising:
a fluid chamber configured to receive a portion of a fluid from the fluid flow, through an inlet fluid port;
a membrane provided adjacent to the fluid chamber, the membrane configured to deform in response to the receipt of the portion of the fluid into the fluid chamber;
a second chamber provided adjacent to the membrane on a side opposite to a side of the fluid chamber;
a sensor provided in the second chamber, the sensor configured to detect deformation of the membrane and generate an input signal associated with the detected deformation of the membrane; and
an electronic circuit board operatively coupled to the sensor, the electronic circuit board configured to receive the input signal from the sensor and provide an output signal in correlation with the flow rate of the fluid flow.

2. The device as claimed in claim 1, wherein the sensor is an ultrasonic transducer configured to detect the deformation of the membrane by generating sonic and/or ultrasonic waves and determining a total time taken by the sonic and/or the ultrasonic waves to travel to the membrane and then return to the sensor.

3. The device as claimed in claim 1, wherein the electronic circuit board is configured to provide the output signal based on a pre-defined threshold value of the flow rate of the fluid flow.

4. The device as claimed in claim 3, wherein the sensor is programmed to have multiple threshold values of the flow rate based on the multiple flow rates.

5. The device as claimed in claim 3, wherein the electronic circuit board is programmed to send the output signal as a notification or a warning to a user device indicating that the flow rate is outside of the operating threshold when the flow rate of the fluid flow exceeds or is lower than the pre-defined threshold value.

6. The device as claimed in claim 1, wherein the fluid chamber, the membrane, the second chamber, the sensor, and the electronic circuit board are arranged inside a housing.

7. The device as claimed in claim 6, wherein a fabrication material of the housing is selected from at least one of Polytetrafluoroethylene (PTFE), a fluoropolymer, and a plastic.

8. The device as claimed in claim 1, wherein a fabrication material of the membrane is selected from at least one of an elastomer, a fluoropolymer, a synthetic rubber, and a plastic.

9. The device as claimed in claim 1, wherein, in the absence of a fluid flow or any amount of fluid in the fluid chamber, the membrane is held in a baseline non-activated position by stretching the membrane over a plurality of mounting pins.

10. The device as claimed in claim 1, further comprising at least one electrical power terminal configured to receive electrical power from a power source.

11. The device as claimed in claim 1, wherein the sensor is configured to be operational in a plurality of modes of operation and calibrated using an encoder.

12. The device as claimed in claim 11, wherein the encoder is configured to:
be used as a push button to switch between the plurality of modes of operation of the sensor;
indicate a current mode of operation of the sensor, through a Light Emitting Diode (LED); and
operate as a knob for adjustment of parameter values of each one of the plurality of modes of operation.
